(19) United States
(12) Patent Application Publication
(10) Pub. No.: US 2025/0176573 A1
(43) Pub. Date: Jun. 5, 2025

(54) SYSTEMS AND METHODS OF COOKING PROFILES IN AN INDOOR SMOKER

(71) Applicant: Haier US Appliance Solutions, Inc., Wilmington, DE (US)

(72) Inventors: Daniel Carballo, Louisville, KY (US); Steven Fox, Louisville, KY (US); Richard Dean Suel, II, Louisville, KY (US)

(21) Appl. No.: 19/047,745

(22) Filed: Feb. 7, 2025

Related U.S. Application Data
(63) Continuation-in-part of application No. 17/826,353, filed on May 27, 2022.

(51) Int. Cl. A23B 4/052; A23L 5/10; H05B 1/02

(52) U.S. Cl. CPC A23B 4/052; A23L 5/17; H05B 1/0263

(57) ABSTRACT

An indoor smoker includes a cabinet defining a smoking chamber, a heating element, a smoke generating assembly, and a controller. The controller is configured to receive a user input which includes a first set point for a cooking parameter, a second set point for the cooking parameter, a first stage limit, and a second stage limit. The controller is also configured to perform a multi-stage cooking profile. The multi-stage cooking profile includes operating, during a first stage, one of the heating element or the smoke generating assembly to provide the first set point of the cooking parameter, detecting the first stage limit, and terminating the first stage and initiating a second stage of the multi-stage cooking profile. The multi-stage cooking profile further includes operating, during the second stage, the one of the heating element or the smoke generating assembly to provide the second set point for the cooking parameter.

### CROSS-REFERENCE TO RELATED APPLICATIONS

This application is a continuation in part of U.S. application Ser. No. 17/826,353, filed May 27, 2022, titled “Systems and Methods of Cooking Profiles in an Indoor Smoker,” which is incorporated herein by reference in its entirety for all purposes.

### FIELD OF THE INVENTION

The present subject matter relates generally to methods for operating an indoor smoker.

### BACKGROUND OF THE INVENTION

Cooking appliances are generally appliances configured to cook food. As such, cooking appliances generally include one or more heating elements in order to impart heat onto the food for cooking. Cooking appliances may generally include stove-top appliances, oven appliances, microwave appliances, smoker appliances, etc. Users can operate a cooking appliance to cook food items as desired by selecting or manipulating various operational features of the cooking appliance, such as e.g., the temperature setting or mode of operation.

Conventional smokers include a smoking chamber and a firebox positioned within or fluidly coupled to the smoking chamber. The firebox is provided with a combustible material, such as wood or wood byproducts, that are ignited or otherwise heated to generate smoke and/or heat. The heat and smoke are routed into the smoking chamber to impart flavor on and cook food items positioned within the smoking chamber. One or more heating elements may be positioned within the smoking chamber and the firebox to maintain the temperatures necessary both for cooking the food and for generating the desired amount of smoke.

During a conventional cooking process, cooking parameters such as temperature, smoke level, or time, may be manually controlled by a user to cook food in a desired way. Additional manual operations by the user may include manipulating one or more food items, such as stirring, wrapping, unwrapping, or otherwise adjusting or physically manipulating the food item(s). Such manual control and/or adjustments may be challenging for a user to remember to perform and may prolong the cooking time, including not only the time for the controls/adjustments to be performed, but also additional cooking time due to heat loss when a door of the cooking appliance is opened to check and/or adjust the food items. Prolonged cooking times are generally not desired, and especially in already lengthy cooking operations, such as smoking or slow-cooking a large portion of meat.

Accordingly, systems and methods which address one or more of the foregoing issues, such as systems and methods of operating an indoor smoker with a higher level of control than in the conventional cooking process would be advantageous, are desired in the art.

### BRIEF DESCRIPTION OF THE INVENTION

Aspects and advantages of the invention will be set forth in part in the following description, or may be apparent from the description, or may be learned through practice of the invention.

In one example embodiment, provided is a method of operating an indoor smoker. The indoor smoker includes a cabinet defining a smoking chamber, a heating element configured for heating the smoking chamber, a smoke generating assembly configured for providing smoke into the smoking chamber, and a controller in operative communication with the heating element and the smoke generating assembly. The method includes receiving, at the controller, a user input which includes a first set point for a cooking parameter, a second set point for the cooking parameter, a first stage limit, and a second stage limit. The method also includes performing, by the controller, a multi-stage cooking profile. The multi-stage cooking profile includes operating, by the controller during a first stage of the multi-stage cooking profile, one of the heating element or the smoke generating assembly to provide the first set point of the cooking parameter, detecting, by the controller, the first stage limit, and terminating the first stage and initiating a second stage of the multi-stage cooking profile in response to detecting the first stage limit. The multi-stage cooking profile further includes operating, by the controller during the second stage of the multi-stage cooking profile, the one of the heating element or the smoke generating assembly to provide the second set point for the cooking parameter.

In another example embodiment, provided is an indoor smoker. The indoor smoker includes a cabinet defining a smoking chamber, a heating element configured for heating the smoking chamber, a smoke generating assembly configured for providing smoke into the smoking chamber, and a controller in operative communication with the heating element and the smoke generating assembly. The controller is configured to receive a user input which includes a first set point for a cooking parameter, a second set point for the cooking parameter, a first stage limit, and a second stage limit. The controller is also configured to perform a multi-stage cooking profile. The multi-stage cooking profile includes operating, by the controller during a first stage of the multi-stage cooking profile, one of the heating element or the smoke generating assembly to provide the first set point of the cooking parameter, detecting, by the controller, the first stage limit, and terminating the first stage and initiating a second stage of the multi-stage cooking profile in response to detecting the first stage limit. The multi-stage cooking profile further includes operating, by the controller during the second stage of the multi-stage cooking profile, the one of the heating element or the smoke generating assembly to provide the second set point for the cooking parameter.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an indoor smoker with a door in a closed position in accordance with an example embodiment of the present disclosure.

FIG. 2 provides a perspective view the example indoor smoker of FIG. 1 with the door opened.

FIG. 3 provides a partial perspective view of the example indoor smoker of FIG. 1 according to an example embodiment of the present subject matter.

FIG. 4 is a front cross-sectional view of the example indoor smoker of FIG. 1 according to an example embodiment of the present subject matter.

FIG. 5 is a side cross sectional view of the example indoor smoker of FIG. 1 according to an example embodiment of the present subject matter.

FIG. 6 is a schematic cross-sectional view of a smoke generating assembly for use with the example indoor smoker of FIG. 1 according to an example embodiment of the present subject matter.

FIG. 7 is a schematic cross-sectional view of a smoldering heater and a smoke barrel of the example smoke generating assembly of FIG. 6 with a rotating auger removed for clarity according to an example embodiment of the present subject matter.

FIG. 8 provides a method of operating the indoor smoker of FIG. 1 in accordance with an example embodiment of the present disclosure.

FIG. 9A provides an example cooking operation in accordance with aspects of the present subject matter.

FIG. 9B provides a continuation of the example cooking operation of FIG. 9A.

FIG. 10 provides a graphical representation of the example cooking operation of FIGS. 9A and 9B.

FIG. 11 provides an example method of operating an indoor smoker in accordance with aspects of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

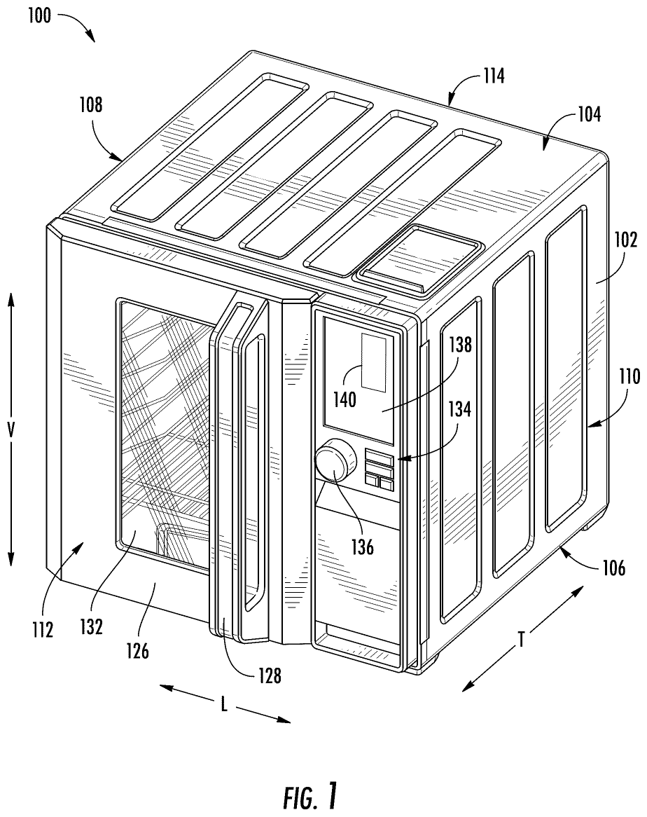

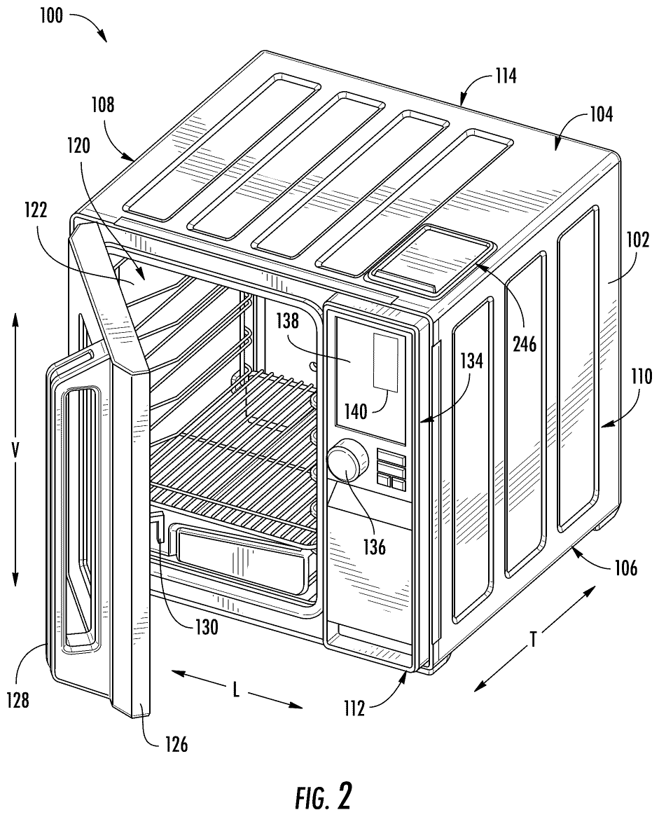

FIGS. 1 and 2 provide perspective views of an indoor smoker 100 according to an example embodiment of the present subject matter with the door in the closed position and the open position, respectively. Indoor smoker 100 generally defines a vertical direction V, a lateral direction L, and a transverse direction T, each of which is mutually perpendicular, such that an orthogonal coordinate system is generally defined. As illustrated, indoor smoker 100 includes an insulated cabinet 102. Cabinet 102 of indoor smoker 100 extends between a top 104 and a bottom 106 along the vertical direction V, between a first side 108 (left side when viewed from front) and a second side 110 (right side when viewed from front) along the lateral direction L, and between a front 112 and a rear 114 along the transverse direction T.

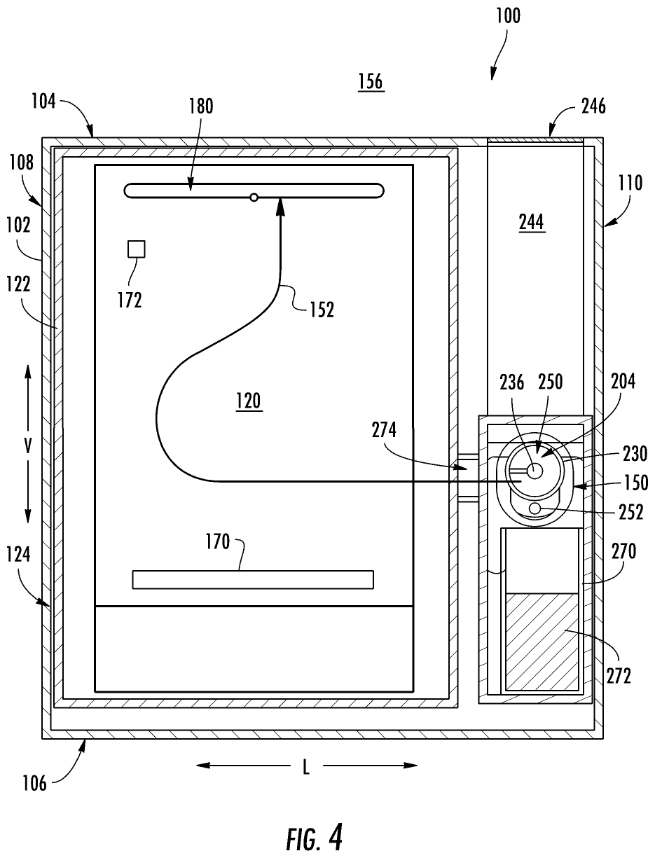

Within cabinet 102 is a smoking chamber 120 which is configured for the receipt of one or more food items to be cooked and/or smoked. In general, smoking chamber 120 is at least partially defined by a plurality of chamber walls 122. Specifically, smoking chamber 120 may be defined by a top wall, a rear wall, a bottom wall, and two sidewalls. These chamber walls 122 may define smoking chamber 120 and an opening through which a user may access food articles placed therein. In addition, chamber walls 122 may be joined, sealed, and insulated to help retain smoke and heat within smoking chamber 120. In this regard, for example, in order to insulate smoking chamber 120, indoor smoker 100 includes an insulation gap 124 (FIG. 4) defined between chamber walls 122 and cabinet 102. According to an example embodiment, insulation gap 124 is filled with insulating material (not shown), such as insulating foam or fiberglass.

Indoor smoker 100 includes a door 126 rotatably attached to cabinet 102 in order to permit selective access to smoking chamber 120. A handle 128 is mounted to door 126 to assist a user with opening and closing door 126 and a latch 130 (FIG. 2) is mounted to cabinet 102 for locking door 126 in the closed position during a cooking or smoking operation. In addition, door 126 may include one or more transparent viewing windows 132 to provide for viewing the contents of smoking chamber 120 when door 126 is closed and also to assist with insulating smoking chamber 120.

Referring still to FIGS. 1 and 2, a user interface panel 134 and a user input device 136 may be positioned on an exterior of cabinet 102. User interface panel 134 may represent a general purpose Input/Output (“GPIO”) device or functional block. In some embodiments, user interface panel 134 may include or be in operative communication with user input device 136, such as one or more of a variety of digital, analog, electrical, mechanical, or electro-mechanical input devices including rotary dials, control knobs, push buttons, and touch pads. User input device 136 is generally positioned proximate to user interface panel 134, and in some embodiments, user input device 136 may be positioned on user interface panel 134. User interface panel 134 may include a display component 138, such as a digital or analog display device designed to provide operational feedback to a user.

Generally, indoor smoker 100 may include a controller 140 in operative communication with user input device 136. User interface panel 134 of indoor smoker 100 may be in communication with controller 140 via, for example, one or more signal lines or shared communication busses, and signals generated in controller 140 operate indoor smoker 100 in response to user input via user input devices 136. Input/Output (“I/O”) signals may be routed between controller 140 and various operational components of indoor smoker 100 such that operation of indoor smoker 100 can be regulated by controller 140.

Controller 140 is a “processing device” or “controller” and may be embodied as described herein. Controller 140 may include a memory and one or more microprocessors, microcontrollers, application-specific integrated circuits (ASICS), CPUs or the like, such as general or special purpose microprocessors operable to execute programming instructions or micro-control code associated with operation of indoor smoker 100, and controller 140 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 140 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

For example, controller 140 may be operable to execute programming instructions or micro-control code associated with an operating cycle of indoor smoker 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 140 as disclosed herein is capable of and may be operable to perform any methods, method steps, or portions of methods as disclosed herein. For example, in some embodiments, methods disclosed herein may be embodied in programming instructions stored in the memory and executed by controller 140.

Although aspects of the present subject matter are described herein in the context of an indoor smoker having a single smoking chamber, it should be appreciated that indoor smoker 100 is provided by way of example only. Other smoking appliances having different configurations, different appearances, and/or different features may also be utilized with the present subject matter, e.g., outdoor smokers, conventional oven appliances, or other suitable cooking appliances. Thus, the example embodiment shown in FIG. 1 is not intended to limit the present subject matter to any particular smoking configuration or arrangement. Moreover, aspects of the present subject matter may be used in any other consumer or commercial appliance where it is desirable to regulate a flow of smoke or harmful emissions in an appliance.

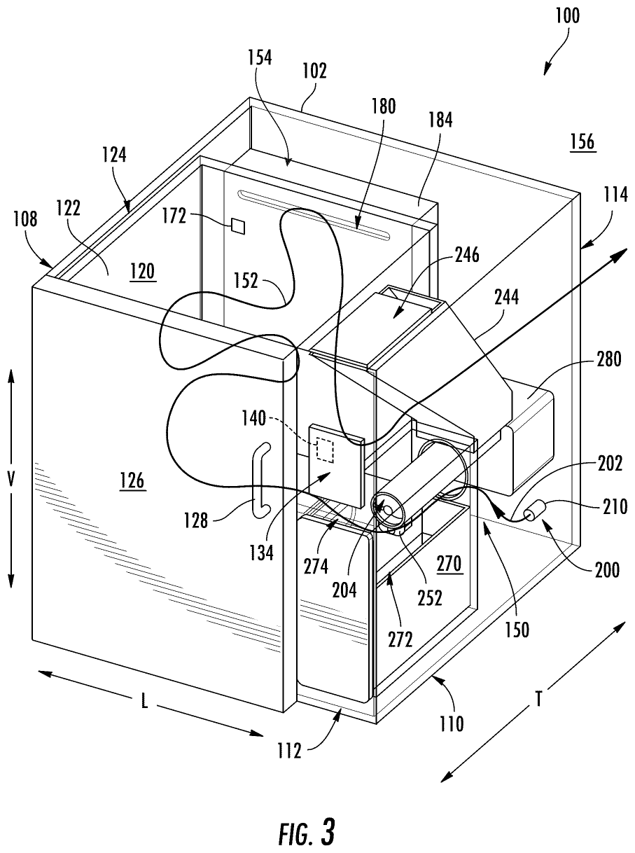

Referring now also to FIG. 3, various internal components of an indoor smoker 100 and their respective functions will be described according to an example embodiment of the present subject matter. In this regard, FIG. 3 illustrates a partial perspective view of an indoor smoker 100 similar to that shown in FIG. 1. As shown, indoor smoker 100 generally includes smoking chamber 120 for receiving items to be cooked/smoked, a smoke generating device or smoke generating assembly 150 for generating a flow of smoke (indicated by reference numeral 152 in FIG. 3), and an exhaust system 154 for safely discharging that the air and/or smoke into an indoor environment 156 (i.e., outside of indoor smoker 100). Each of these systems and components will be described in detail below.

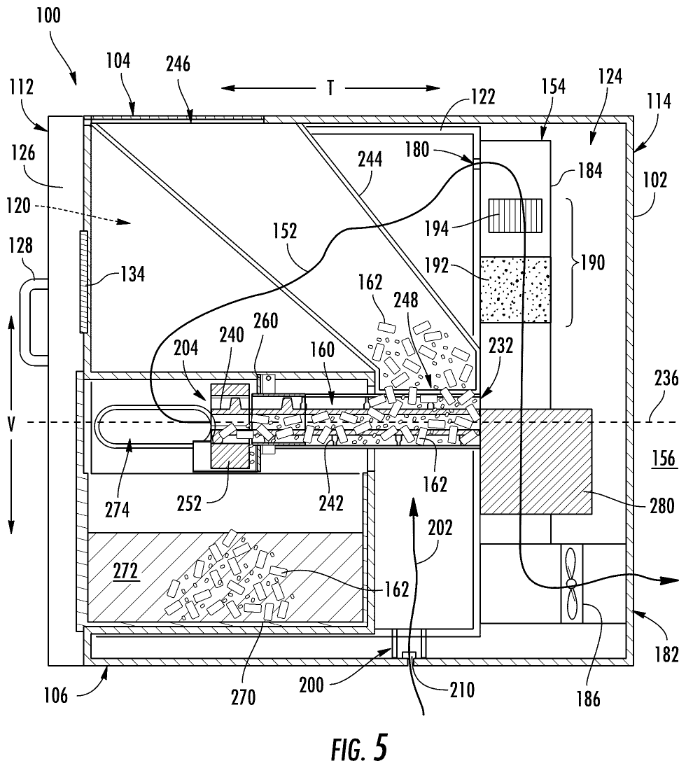

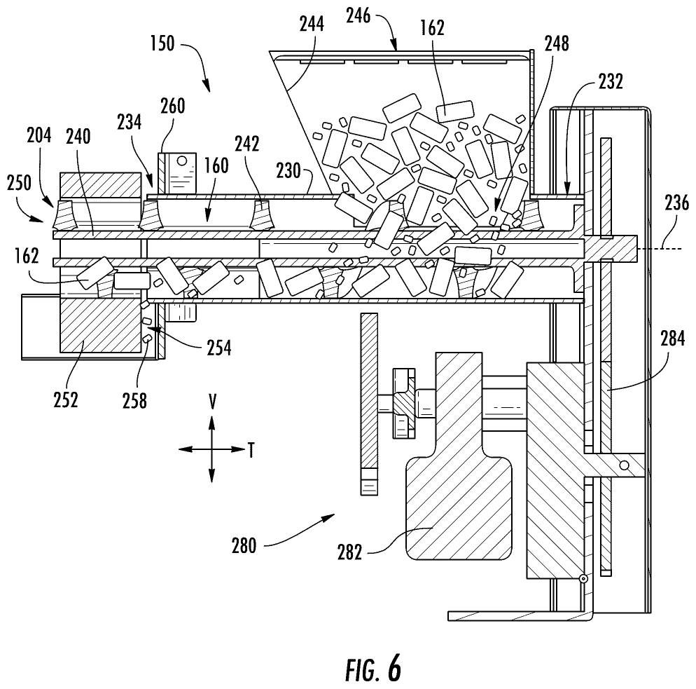

Referring to FIGS. 5 and 6, smoke generating assembly 150 generally defines a smoldering chamber 160 which is configured for receiving combustible material 162. As used herein, “combustible material” is generally used to refer to any suitable material positioned within smoldering chamber 160 for generating smoke. Specifically, according to example embodiments, combustible material 162 includes wood or wood byproducts, such as wood chunks, wood chips, wood pellets, or wood resin. According to the example embodiment, smoke generating assembly 150 may include a door or another access panel (not shown) for providing selective access to smoldering chamber 160, e.g., to add additional combustible material 162. Smoke generating assembly 150 will be described in more detail below with respect to FIGS. 3 through 7.

As shown in FIG. 4, in order to ensure a desirable cooking temperature within smoking chamber 120, indoor smoker 100 further includes a chamber heater 170 that is positioned within or otherwise in thermal communication with smoking chamber 120 for regulating the temperature in smoking chamber 120. In general, chamber heater 170 may include one or more heating elements positioned within cabinet 102 for selectively heating smoking chamber 120. For example, the heating elements may be electric resistance heating elements, gas burners, microwave heating elements, halogen heating elements, or suitable combinations thereof. Notably, because chamber heater 170 is operated independently of smoke generating assembly 150 (e.g., as described below), smoking chamber 120 may be maintained at any suitable temperature during a smoking process. More specifically, for example, chamber heater 170 may be turned off or on a very low setting for smoking cheeses or may be turned on high for quickly cooking and smoking meats.

In some embodiments, indoor smoker 100 also includes one or more sensors that may be used to facilitate improved operation of the appliance, such as described below. For example, indoor smoker 100 may include one or more temperature sensors which are generally operable to measure the internal temperature in indoor smoker 100, e.g., within smoking chamber 120 and/or smoldering chamber 160. More specifically, as illustrated, indoor smoker 100 includes a temperature sensor 172 positioned within smoking chamber 120 and being operably coupled to controller 140. In some embodiments, controller 140 is configured to vary operation of chamber heater 170 based on one or more temperatures detected by temperature sensor 172.

As described herein, “temperature sensor” may refer to any suitable type of temperature sensor. For example, the temperature sensors may be thermocouples, thermistors, or resistance temperature detectors. In addition, temperature sensor 172 may be mounted at any suitable location and in any suitable manner for obtaining a desired temperature measurement, either directly or indirectly. Although example positioning of certain sensors is described below, it should be appreciated that indoor smoker 100 may include any other suitable number, type, and position of temperature sensors according to alternative embodiments.

As mentioned briefly above, indoor smoker 100 further includes an exhaust system 154 which is generally configured for safely discharging the flow of smoke 152 from indoor smoker 100. Specifically, according to the illustrated embodiment, exhaust system 154 generally extends between a chamber outlet 180 and a discharge vent 182 defined by cabinet 102 for directing the flow of smoke 152 from smoking chamber 120 to the environment 156. Although an example exhaust system 154 is described below, it should be appreciated that variations and modifications may be made while remaining within the scope of the present subject matter. For example, the routing of ducts, the catalytic converter arrangement, and the types of sensors used may vary according to alternative embodiments.

As shown, exhaust system 154 includes an exhaust duct 184 that generally extends between and provides fluid communication between chamber outlet 180 and discharge vent 182. Indoor smoker 100 further includes an air handler 186 that is operably coupled with exhaust duct 184 facilitating the smoldering process and smoke generating process. For example, air handler 186 urges the flow of smoke 152 through exhaust duct 184 and out of discharge vent 182 to environment 156. According to the illustrated example embodiment, air handler 186 is an axial fan positioned within exhaust duct 184. However, it should be appreciated that according to alternative embodiments, air handler 186 may be positioned at any other suitable location and may be any other suitable fan type, such as a tangential fan, a centrifugal fan, etc.

In addition, according to an example embodiment, air handler 186 is a variable speed fan such that it may rotate at different rotational speeds, thereby generating different air flow rates. In this manner, the amount of smoke drawn from smoldering chamber 160 may be continuously and precisely regulated. Moreover, by pulsing the operation of air handler 186 or throttling air handler 186 between different rotational speeds, the flow of smoke 152 drawn into smoking chamber 120 may enter from a different direction, may have a different flow velocity, or may generate a different flow pattern within smoking chamber 120. Thus, by pulsating the variable speed fan or otherwise varying its speed, the flow of smoke 152 may be randomized, thereby eliminating stagnant regions within smoking chamber 120 and better circulating the flow of smoke 152 to provide a more even cooking result.

As illustrated, indoor smoker 100 further includes a catalytic converter 190 which is positioned within exhaust duct 184 for lowering or removing volatile organic compounds (VOCs) from the flow of smoke 152. As used herein, “catalytic converter” or variations thereof may be used to refer to any component, machine, or device that is configured for removing or lowering volatile organic compounds (VOCs), toxic gases, harmful emissions, pollutants, or undesirable compounds from a flow of air and smoke. For example, according to the illustrated embodiment, catalytic converter 190 generally includes a catalytic element 192 and a catalyst heater 194. Although catalytic converter 190 is illustrated herein as being positioned within exhaust duct 184, it should be appreciated that according to other embodiments catalytic converter 190 be positioned at any other suitable location, so long as catalytic converter 190 is inline with the flow of smoke 152, such that volatile organic compounds may be reduced.

In general, catalytic element 192 includes a material that causes an oxidation and a reduction reaction. For example, precious metals such as platinum, palladium, and rhodium are commonly used as catalyst materials, though other catalysts are possible and within the scope of the present subject matter. In operation, the catalytic element 192 may combine oxygen (O2) with carbon monoxide (CO) and unburned hydrocarbons to produce carbon dioxide (CO2) and water (H2O). In addition, according to example embodiments, catalytic element 192 may remove nitric oxide (NO) and nitrogen dioxide (NO2).

Notably, catalytic converters typically require that the catalyst be heated to a suitably high temperature in order to catalyze the necessary chemical reactions. Therefore, catalyst heater 194 is in thermal communication with catalytic element 192 for heating it to a suitable temperature, such as approximately 800° F. According to the illustrated embodiment, catalyst heater 194 is positioned upstream of catalytic element 192 to provide thermal energy through convection. However, it should be appreciated that according to alternative embodiments, catalyst heater 194 may be in direct contact with catalytic element 192 to provide thermal energy through conduction, or may be thermally coupled to catalytic element 192 in any other suitable manner. In order to ensure a catalyst temperature of catalytic element 192 remains above a temperature suitable for controlling emissions, indoor smoker 100 may further include a catalyst temperature sensor (not shown) that may be monitored by controller 140.

Referring now specifically to FIGS. 3 through 7, the construction and operation of smoke generating assembly 150 will be described in more detail according to an example embodiment of the present subject matter. As shown in FIG. 5, indoor smoker 100 defines an air inlet 200 for receiving air to support the combustion or smoldering process. Specifically, air inlet 200 is configured for receiving a flow of combustion air (indicated by reference numeral 202 in FIG. 5) from the ambient environment 156 surrounding indoor smoker 100 or from another air supply source. During a smoking process, combustible material 162 is ignited and the flow of combustion air 202 supports the smoldering process to generate the flow of smoke 152. Smoke generating assembly 150 further defines a smoke outlet 204 for providing a flow of smoke 152 into smoking chamber 120 during a smoking operation, as will be described in detail below.

In addition, indoor smoker 100 may further include features for preventing or regulating the flow of combustion air 202 from entering indoor smoker 100 from environment 156 when the flow of such air is not desired. In this regard, for example, indoor smoker 100 may include an inlet check valve 210 which is operably coupled to air inlet 200. In general, this check valve prevents the flow of combustion air 202 from entering smoldering chamber 160 when not desired. For example, inlet check valve 210 may have a “cracking pressure,” which is used herein to refer to the pressure, or more precisely the negative pressure, required within smoldering chamber 160 to open inlet check valve 210. In this manner, inlet check valve 210 may be designed to permit the flow of combustion air 202 only when air handler 186 is operating and urging air through smoldering chamber 160, thus facilitating the quick and effective asphyxiation of combustible material 162 within smoldering chamber 160 when desired.

Referring now specifically to FIGS. 5 through 7, according to the illustrated embodiment, smoke generating assembly 150 generally includes a smoke barrel 230 that defines smoldering chamber 160. Specifically, smoke barrel 230 extends between a first end 232 and a second end 234 substantially along a central axis 236. Specifically, as illustrated, central axis 236 extends substantially within a horizontal plane within cabinet 102, e.g., directly along the transverse direction T. In general, smoke barrel 230 is configured for receiving the combustible material 162 and facilitating a smoldering process. As shown, smoke barrel 230 has a substantially cylindrical shape and is formed from a substantially rigid and temperature resistant material, such as steel. However, it should be appreciated that smoke barrel 230 may be formed from different materials, may have different geometries, and may be configured differently within cabinet 102 according to alternative embodiments of the present subject matter.

Smoke generating assembly 150 further includes a rotating auger 240 that is rotatably mounted within smoldering chamber 160 and generally rotates about central axis 236, e.g., such that rotating auger 240 is coaxial with smoke barrel 230. As shown, an outer diameter of rotating auger 240 is substantially equivalent to an inner diameter of smoke barrel 230, such that a helical blade 242 of rotating auger 240 may advance combustible material 162 within smoldering chamber 160 as rotating auger 240 is rotated about central axis 236. More specifically, the combustible material 162 is generally urged from first end 232 toward second end 234 of smoke barrel 230.

As illustrated, smoke generating assembly 150 may further include a hopper 244 that is generally configured for storing and selectively depositing combustible material 162 into smoldering chamber 160. More specifically, as illustrated, hopper 244 may be a large, tapered reservoir with a top opening 246 positioned at top 104 of cabinet 102. A user may fill hopper 244 by pouring or providing combustible material 162 into hopper 244 through top opening 246. Hopper 244 may taper toward a supply opening 248 positioned at a bottom of hopper 244. As shown, supply opening 248 opens into smoldering chamber 160 at a top of smoke barrel 230. More specifically, supply opening 248 is joined to smoke barrel 230 proximate first end 232 of smoke barrel 230. In this manner, fresh combustible material 162 is typically provided into smoldering chamber 160 proximate first end 232 of smoke barrel 230 and is urged by rotating auger 240 toward second end 234 of smoke barrel 230. As illustrated, smoke generating assembly 150 may generally define a discharge port 250 proximate second end 234 of smoke barrel 230 for discharging consumed combustible material 162.

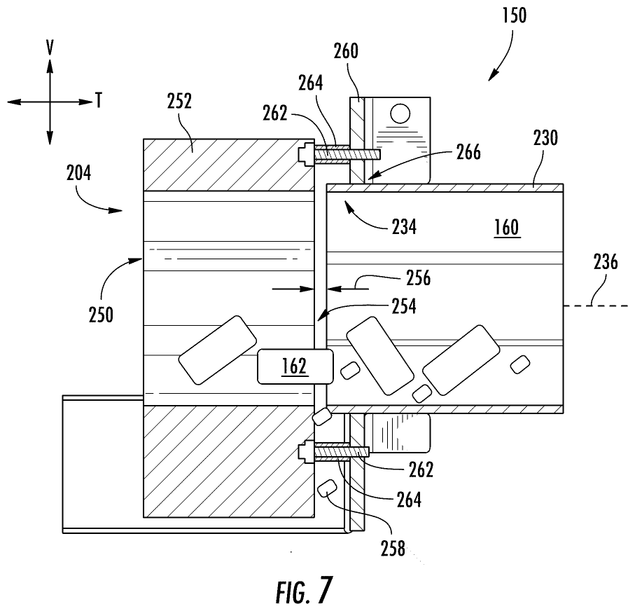

As shown in FIGS. 6 and 7, smoke generating assembly 150 includes one or more smoldering heaters 252 which are positioned adjacent smoldering chamber 160 or otherwise placed in thermal communication with combustible material 162 stored in smoldering chamber 160 for smoldering combustible material 162. According to an example embodiment, smoldering heater 252 may include one or more cartridge heaters or silicon nitride igniters. Alternatively, smoldering heater 252 may include any other suitable type, position, and configuration of heating elements. As used herein, the term “heating element,” “heaters,” and the like may generally refer to electric resistance heating elements, gas burners, microwave heating elements, halogen heating elements, or suitable combinations thereof.

As used herein, the verb “smolder” or variations thereof is intended to refer to burning a combustible material (e.g., combustible material 162) slowly such that smoke is generated but little or no flame is generated. In this manner, the combustible material is not expended quickly, but a large amount of smoke is generated for the smoking process. Notably, the burn rate of combustible material and the amount of smoke generated is regulated using smoldering heater 252 positioned within smoldering chamber 160. For typical combustible material used in smokers, e.g., wood and wood byproducts, a typical smoldering temperature is between about 650° F. and 750° F. However, the exact temperature may vary depending on the combustible material used, the air flow rate through smoldering chamber 160, the level of combustible material 162, and other factors.

According to the example illustrated embodiment, smoldering heater 252 is positioned proximate second end 234 of smoke barrel 230. For example, smoldering heater 252 may at least partially define smoke outlet 204 of smoke generating assembly 150. Specifically, as illustrated, smoke outlet 204 corresponds to discharge port 250 of smoke generating assembly 150, which may simply be an open end of smoldering heater 252. In this manner, as rotating auger 240 rotates, combustible material 162 positioned within smoldering chamber 160 is slowly but progressively advanced past smoldering heater 252. After combustible material 162 positioned near smoldering heater 252 is consumed or smoldered, rotating auger 240 may rotate to advance the consumed material toward discharge port 250 where it may be pushed out of smoldering chamber 160.

Specifically, as illustrated, smoldering heater 252 may be positioned adjacent smoke barrel 230, e.g., downstream of second end 234 of smoke barrel 230. More specifically, according to example embodiments of the present subject matter, smoldering heater 252 may be spaced apart from the second end 234 of smoke barrel 230 to define an igniter gap 254 between smoke barrel 230 and smoldering heater 252. More specifically, igniter gap 254 may be a void defined between smoke barrel 230 and smoldering heater 252 and may define a gap width 256 measured along the central axis 236 of smoke barrel 230.

As explained briefly above, combustible material 162 may have a general tendency of at least partially breaking down and forming dust or other small particles, referred to herein generally as pellet dust 258. In this regard, although combustible material 162 may initially be provided as solid pellets, these pellets may break down, e.g., due to agitation within hopper 244 or under the force of rotating auger 240 such that pellet dust 258 is formed. Moreover, as smoke generating assembly 150 is heated by smoldering heater 252, the original combustible material 162 may have a tendency to dry out and further accelerate the process of pellets breaking down into pellet dust 258. Notably, this pellet dust 258 may create undesirable conditions, e.g., by creating a dust layer or “raft” with in a water container (e.g., as described in more detail below) which may support combustible material 162 above the water thereby preventing the combustible material 162 from being extinguished when dumped into the extinguishing container. In addition, this pellet dust may combust in an undesirable manner or at an undesirable rate, may coat surfaces of smoke generating assembly 150, etc.

As a result, igniter gap 254 may be particularly sized and positioned for facilitating the removal, collection, and/or rerouting of pellet dust 258 while retaining usable combustible material 162 for smoldering via smoldering heater 252. In this regard, for example, gap width 256 may be between about ten and three-hundred thousandths of an inch, between about fifty and two-hundred thousandths of an inch, or about one-hundred thousandths of an inch. It should be appreciated that the spacing may vary as needed depending on the application, the combustible material used, and the size, shape, and geometry of combustible material 162. In addition, it should be appreciated that igniter gap 254 may be integrally formed into smoke barrel 230 and/or smoldering heater 252 instead of having a physical separation between these two components. In this regard, for example, one or both of smoldering heater 252 and smoke barrel 230 may define one or more apertures for permitting pellet dust 258 to fall through these components under the force of gravity.

As shown in FIG. 7, smoldering heater 252 may be mounted within indoor smoker 100 using a mounting bracket 260. In this regard, mounting bracket 260 may be secured to cabinet 102 or another suitable structure within indoor smoker 100 for supporting smoldering heater 252 adjacent smoke barrel 230 and in a manner that defines igniter gap 254. For example, as illustrated, smoldering heater 252 may be mounted to the mounting bracket 260 using a plurality of fasteners 262 that each pass through an insulating standoff 264, e.g., such as a ceramic standoff. As explained below, the standoffs 264 may be used to maintain the desirable igniter gap 254 as well as provide a thermal break between smoke barrel 230 and smoldering heater 252.

In addition, mounting bracket 260 may define a barrel aperture 266 that is designed to receive second end 234 of smoke barrel 230. Specifically, for example, second end 234 of smoke barrel 230 may be positioned and/or float within barrel aperture 266 such that the igniter gap 254 may be maintained between smoke barrel 230 and smoldering heater 252. Notably, in addition to permitting pellet dust 258 to fall out of smoke generating assembly 150 prior to passing through smoldering heater 252, igniter gap 254 may serve to maintain a thermal break or facilitate thermal isolation between smoldering heater 252 and smoke barrel 230. In this manner, further drying out of combustible material 162 may be prevented and pellet dust 258 may be minimized prior to the combustible material 162 reaching smoldering heater 252.

According to example embodiments, smoldering heater 252 may be positioned on a distal end of rotating auger 240, e.g., aligned along central axis 236 proximate second end 234. As such, rotating auger 240 may pass through smoke barrel 230 and through a central aperture smoldering heater 252 to extend out of discharge port 250. In this manner, rotating auger 240 may serve to advance combustible material 162 from first end 232 of smoke barrel 230, past second end 234 of smoke barrel 230, through and across smoldering heater 252, then out of discharge port 250.

Seen in FIG. 5, a waste container 270 may be configured for receiving consumed combustible material 162 when discharged from smoke generating assembly 150. In this regard, for example, waste container 270 may be positioned directly below smoke barrel 230, smoldering heater 252, and/or discharge port 250 such that used combustible material 162 may fall therein and immediately extinguish. For example, according to the illustrated embodiment, waste container 270 is filled with water 272 to immediately extinguish combustible material 162 when dropped into container 270. However, it should be appreciated that other liquids or materials for extinguishing combustible material 162 may be contained within waste container 270. In addition, as illustrated, waste container 270 may be positioned below or directly define a chamber inlet 274 that is positioned adjacent smoke outlet 204. In this manner, the flow of smoke 152 exiting smoke barrel 230 may pass directly into smoking chamber 120 through chamber inlet 274 while consumed combustible material 162 may fall directly into water 272 within container 270.

As illustrated in FIG. 6, smoke generating assembly 150 may further include a drive mechanism 280 that is mechanically coupled to rotating auger 240. Controller 140 (or another dedicated controller) may be in operative communication with drive mechanism 280 and may be configured for intermittently rotating the rotating auger 240 to advance combustible material 162 along central axis 236. Specifically, as illustrated, drive mechanism 280 may include a drive motor 282 and a transmission assembly 284 or another suitable geared arrangement for transferring torque from drive motor 282 to rotating auger 240. As used herein, “motor” may refer to any suitable drive motor and/or transmission assembly for driving rotating auger 240. For example, drive motor 282 may be a brushless DC electric motor, a stepper motor, or any other suitable type or configuration of motor. For example, drive motor 282 may be an AC motor, an induction motor, a permanent magnet synchronous motor, or any other suitable type of AC motor. In addition, drive motor 282 and transmission assembly 284 may include any suitable motor or transmission sub-assemblies, clutch mechanisms, or other components.

In order to facilitate proper smoldering of combustible material 162, it may be desirable to drive rotating auger 240 intermittently, e.g., in a non-continuous manner. Specifically, according to an example embodiment, rotating auger 240 may be rotated for a particular time duration once during every predetermined rotation period. For example, the time duration of rotation may be the amount of time drive mechanism 280 should drive rotating auger 240 to discharge all combustible material 162 that is smoldering from smoke barrel 230. In addition, the predetermined rotation period may be the amount of time necessary for a fresh portion of the smoldering material 162 to be consumed. Notably, drive mechanism 280 may discharge combustible material 162 from smoke barrel 230 before combustible material 162 is fully consumed, e.g., to prevent forming ash which may introduce acrid smoke flavors. According to an example embodiment, the time duration of rotation is approximately twelve (12) seconds while the predetermined rotation period is three (3) minutes. Other rotation schedules are possible and within the scope of the present subject matter. Indeed, such rotation schedules may vary based on a variety of factors, such as the combustible material used, the temperature of the smoldering heater, the rate of air flow through smoke barrel 230, etc.

Thus, during operation of indoor smoker 100, air handler 186 draws the flow of combustion air 202 into smoldering chamber 160 through air inlet 200. The flow of combustion air 202 and combustible material 162 in the smoldering chamber 160 generate the flow of smoke 152 which is drawn into smoking chamber 120 as described herein. The flow of smoke 152 passes through smoking chamber 120 for performing a smoking process on food items positioned therein before exiting smoking chamber 120 through chamber outlet 180. Air handler 186 then continues to urge the flow of smoke 152 through catalytic converter 190 and exhaust duct 184 before passing out discharge vent 182.

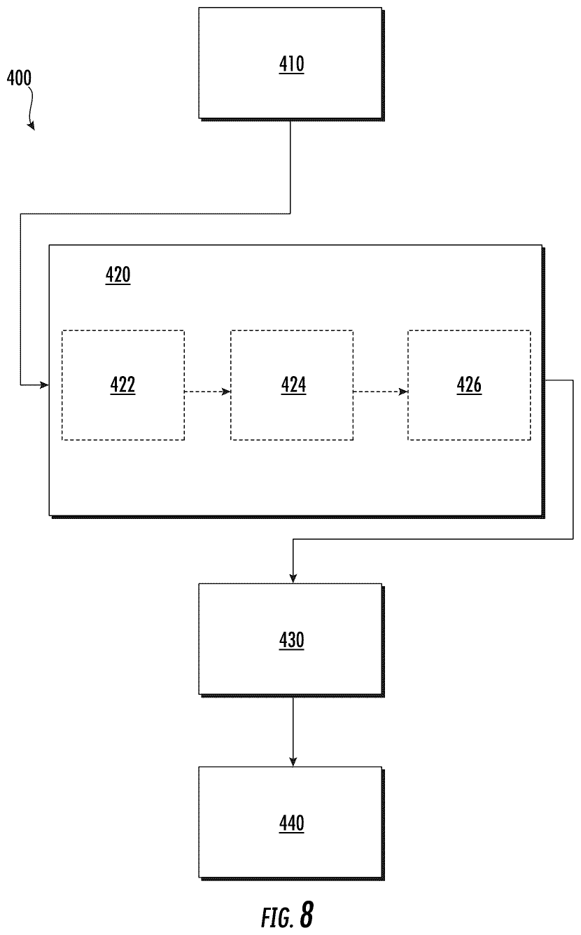

Shown in FIG. 8 is one example method 400 of operating an indoor smoker. Method 400 is described in greater detail below in the context of indoor smoker 100, however, it will be understood that method 400 may be used in or with other indoor smokers, outdoor smokers, or other cooking appliances, such as oven appliances, in alternative example embodiments. In addition, although FIG. 8 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

At 410, method 400 of indoor smoker 100 may begin with controller 140 initializing a start-up sequence. The start-up sequence may include the activation of a plurality of components including, but not limited to, air handler 186, catalyst heater 194, chamber heater 170, the igniter in smoldering heater 252, and/or auger 240.

At 420, after finishing the start-up sequence, controller 140 may begin the profile state sequence. The profile state sequence may include a plurality of cooking profiles, such as cooking profile 422, cooking profile 424, or cooking profile 426. The profile state sequence may include various cooking profiles at 420. For instance, in certain example embodiments, there may be as few as one (1) cooking profile or there may be as many as twenty (20) cooking profiles in the profile state sequence. As then would be understood by those of skill in the art, cooking profiles 422, 424, and 426 are provided by way of example only. Cooking profiles may be input into indoor smoker 100 by a user or may be shared to other users through internet connectivity, i.e., cooking profiles may be customizable by a user. In each cooking profile 422, 424, and 426 of the profile state sequence at 420, cooking parameter(s) such as baking temperature and smoke intensity may be set as the cooking parameter(s) for the cooking profile. In particular, baking temperature and smoke intensity may be a start condition(s) for the cooking profile. Thus, the other parameters, such as time and a meat probe temperature, may be end condition(s) for the cooking profile.

For example, cooking profile 422 may set an end condition of a time of thirty (30) minutes at a start condition of a smoke intensity of “high.” For the duration of the designated time, controller 140 may operate indoor smoker 100 to produce a “high” amount of smoke. Once the cooking parameter of cooking profile 422 is satisfied, i.e., the end condition is met, the next cooking profile may begin; thus, in the present example embodiment, cooking profile 424 may commence. In cooking profile 424, the cooking parameter may be a baking temperature of one-hundred and fifty degrees Celsius (150° C.) for a designated time of two (2) hours. Once the cooking parameter of cooking profile 424 is satisfied, profile state sequence moves to the next cooking profile; thus, in the present example embodiment, cooking profile 426 may commence. Cooking profile 426 may include a baking temperature of one-hundred and fifty degrees Celsius (150°) for a baking time of twenty (20) minutes, and a smoking time of ten (10) minutes at a “low” intensity, in order to reach a meat probe temperature of seventy degrees Celsius (70° C.). Once each of the cooking parameters of cooking profile 426 are satisfied, the profile state sequence may be complete. The purpose of this example is to describe the functionality of the present disclosure and is not intended to be limiting to any embodiment or cooking profile. Cooking profiles 422, 424, and 426 may be in a defined order such that the food is cooked in a desired way, i.e., a user may set the order of the cooking profiles. In certain example embodiments, one or more (e.g., all) of the cooking parameter(s) may vary between each of the cooking profiles in the profile state sequence. In other words, the profile state sequence may be a multi-stage cooking profile, where each cooking profile is a stage of the multi-stage cooking profile, as will be described further below.

In other example embodiments, the profile state sequence may include a profile state time limit to control the amount of time indoor smoker 100 may spend in the profile state sequence before moving on. At 430, the profile state sequence is complete and controller 140 may initialize an evacuation sequence. The evacuation sequence may include the deactivation of a plurality of components including, but not limited to, air handler 186, catalyst heater 194, the igniter in smoldering heater 252, and/or auger 240. In the present example embodiment, at 440 controller 140 may perform a holding sequence. The holding sequence may hold indoor smoker 100 at a temperature for an amount of time. As such, the hold sequence may function as a timed bake, or a “keep warm” mode. For example, at the completion of the evacuation sequence, indoor smoker 100 may hold a temperature of one-hundred and fifty degrees Celsius (150°), for twenty (20) minutes time. At the conclusion of the holding sequence, method 400 may have concluded and the cooking/smoking of the contents of indoor smoker 100 may be complete.

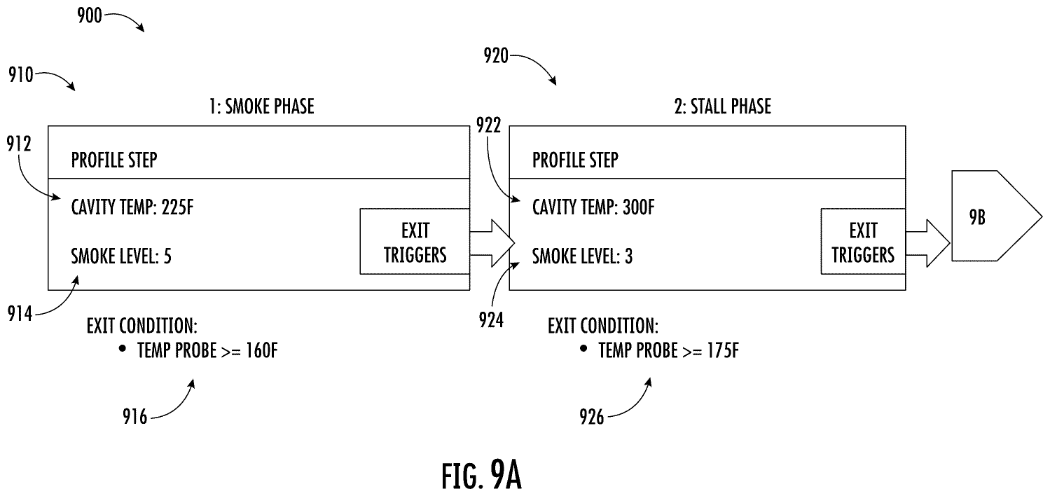

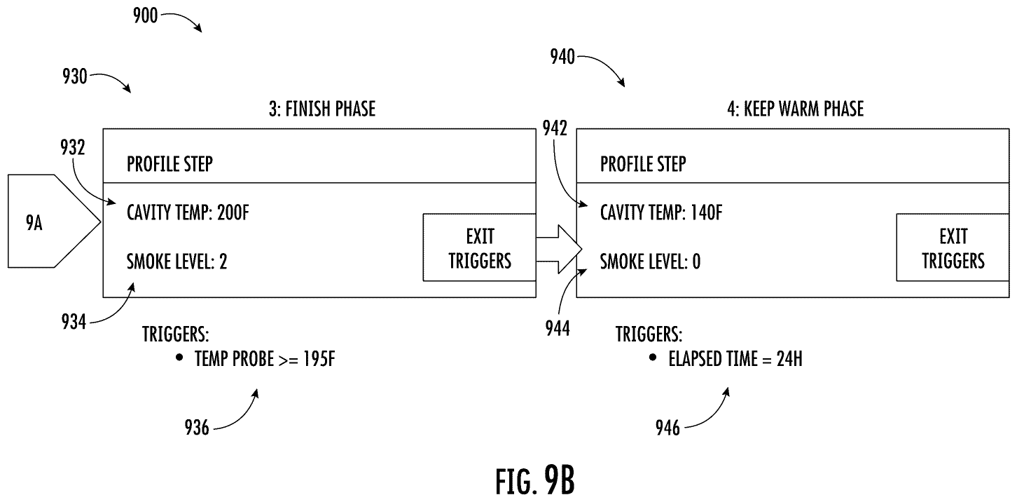

Turning now to FIGS. 9A and 9B, provided is an exemplary cooking profile 900. The particular example profile provided in FIGS. 9A and 9B may be used, for example, to cook brisket. As illustrated in FIGS. 9A and 9B, the cooking profile 900 is a multi-stage profile. In general, the multi-stage cooking profile 900 may include a sequence of profile steps/stages where each step/stage includes user-defined end/exit condition(s) or exit triggers. In other words, when the exit conditions are met, the next profile step is made active.

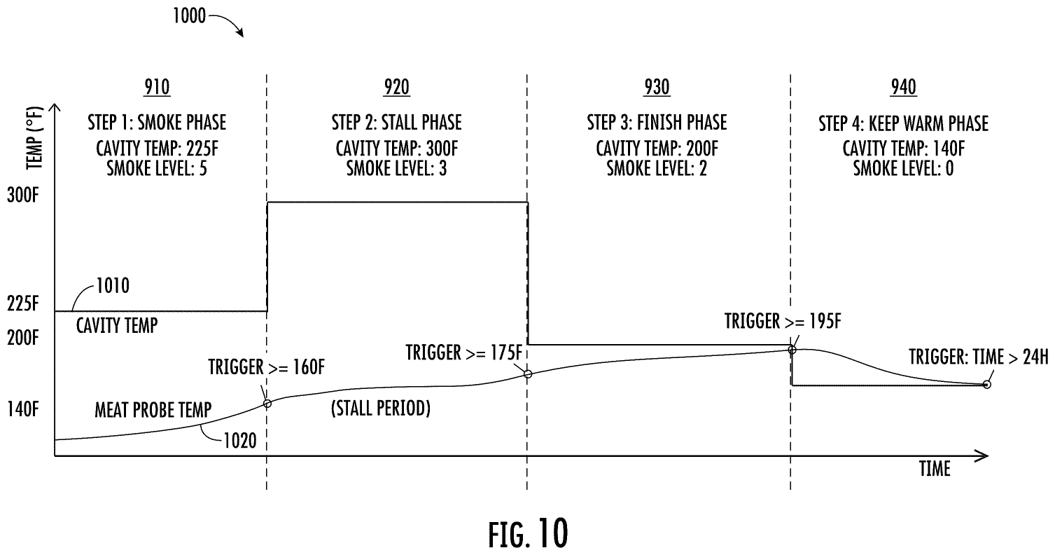

In this particular example, the cooking profile 900 includes four phases or stages, a smoke phase 910, a stall phase 920, a finish phase 930, and a keep warm phase 940. In additional embodiments, different phases may be provided, the phases may be provided in different orders (including repeated phases, such as a second smoke phase after the stall phase), different numbers of phases may be provided, e.g., two phases or three phases, or more than four phases, among other possible variations which may be made independently or in various combinations with each other. Further, it is to be understood that the exemplary cooking profile 900 in FIGS. 9A, 9B, and 10 is not intended to be limiting and is provided by way of example only, e.g., cooking profiles according to various embodiments of the present invention may be used with different food types, the number of cooking parameters may vary, the values of one or more cooking parameters may vary, etc. For example, some example embodiments may include more than two (2) cooking parameters. As would be understood by those of skill in the art, the example provided in FIGS. 9A, 9B, and 10 is provided by way of example only, e.g., the provided names of phases/stages, types and values of cooking parameters and exit conditions/stage limits are provided by way of example only.

Referring now specifically to FIG. 9A, in the exemplary cooking profile 900, the first stage is a smoke phase 910. In this example, each phase includes two cooking parameters and an exit condition. In particular, the smoke phase 910 includes a cavity temperature set point 912 and a smoke level setpoint 914, with a temperature-based exit condition 916, where the exit condition is defined by a meat probe temperature.

For example, temperature sensor 172 is positioned within smoking chamber 120 and is generally operable to measure the internal temperature in indoor smoker 100, e.g., the cavity/chamber temperature within smoking chamber 120. In general, the smoke level, e.g., how much smoke is generated or otherwise the intensity of smoke, may, in this example, be assigned a numerical value of zero (0) through five (5), where a zero (0) smoke level indicates no smoke is to be provided by smoke generating assembly 150 and a five (5) smoke level indicates a “high” amount of smoke is to be provided by smoke generating assembly 150. In general, a “high” level of smoke, as indicated by smoke level five (5), may indicate more smoke generation by smoke generating assembly 150 than smoke levels lower than five (5), such as a smoke level of three (3), e.g., a “medium” level of smoke, or such as a smoke level of one (1), e.g., a “low” level of smoke. In general, in order to generate the different smoke levels, indoor smoker 100 may increase airflow provided by air handler 186, and/or may increase the amount of combustible material 162 smoldering within smoldering chamber 160, such as by rotating auger 240 as described above.

In general, a meat probe (not shown) may measure an internal temperature of the food item within smoking chamber 120. For example, the meat probe may be operably coupled to controller 140 and inserted into the food item within smoking chamber 120 for providing the internal temperature of the food item. In particular, controller 140 may be configured to vary operation of smoke generating assembly 150 and/or chamber heater 170 based on the internal temperature detected by the meat probe, e.g., based on the meat probe temperature.

For example, the smoke phase 910 includes a first cooking parameter, e.g., cavity temperature 912, and a second cooking parameter, e.g., smoke level 914, which are provided by a user. In particular, the first cooking parameter of cavity temperature 912 is provided by the user at a first set point of two hundred and twenty five degrees Fahrenheit (225° F.) and the second cooking parameter of smoke level 914 is provided by the user at a first set point of five (5), e.g., the “high” smoke level. Additionally, the smoke phase 910 (the first stage) includes an exit condition, or a stage limit 916, provided by the user to indicate the transition point from the smoke phase (the first stage) to the next stage/phase, e.g., the stall phase (the second stage) at (920). In particular, the exit condition/stage limit 916 provided by the user is a meat probe temperature of one hundred and sixty degrees Fahrenheit (160° F.).

As stated above, the present example cooking profile 900 may be an example cooking operation for cooking brisket. As such, the smoke phase may be the first stage of the cooking operation to smoke and heat brisket. In general, smoking meat, such as brisket, during the first phase/stage of the cooking profile is the optimal time for the meat to absorb smoke flavor, e.g., meat generally picks up the most smoke flavor in the first four (4) to six (6) hours of smoking. This is generally because the surface of the meat is moist with condensation from the cool meat in the warm smoker environment. Accordingly, it may be advantageous to set the smoke level to the maximum value, e.g., five (5) or “high,” for the first stage of cooking.

Turning ahead briefly to FIG. 10, illustrated is a graph 1000 of the exemplary cooking profile 900. In general, the cavity temperature, indicated by line 1010, is held at two hundred and twenty five degrees Fahrenheit (225° F.) for the duration of the smoke phase. For example, the cavity temperature is held constant until the exit condition/stage limit is met, e.g., the smoke phase exit condition/stage limit is provided in graph 1000 as a meat probe temperature indicated by line 1020. In particular, during the smoke phase (the first stage), as the cavity temperature 1010 is held constant, the meat probe temperature 1020 gradually rises to the smoke phase exit condition/stage limit.

As may be generally understood by those of skill in the art, cooking larger cuts of meat, such as brisket and pork shoulder, typically “stall” between one hundred and fifty degrees Fahrenheit (150° F.) and one hundred and seventy degrees Fahrenheit (170° F.). The stall phase generally includes an internal temperature of the meat stalling or otherwise slowing down with regards to the rising of the internal temperature, because of evaporative cooling on the surface of the meat, e.g., as fat, collagen, etc., is breaking down and sweating on the surface. The stall phase may cause difficulty for a user in planning around cooking the meat, because the stall phase may last for relatively unpredictable amounts of time, e.g., the stall phase may last from one hour (1 h) to numerous hours, such as more than six hours (6 h).

Typical ways to overcome the stall phase include manual interaction with the meat, e.g., to wrap the meat in foil or butcher paper when entering the stall range. However, such manual control and/or adjustments may prolong the cooking time, including the time for the controls/adjustments to be performed, and also additional cooking time due to heat loss when a door of the cooking appliance, such as door 126 of indoor smoker 100, is opened to check and/or adjust the food items.

Referring again to FIG. 9A, in the exemplary cooking profile 900, the second stage is a stall phase 920. In particular, the stall phase 920 includes a cavity temperature set point 922 and a smoke level setpoint 924, with a temperature-based exit condition 926. In particular, the stall phase 920 includes a second set point of the first cooking parameter, e.g., cavity temperature 922, and a second set point of the second cooking parameter, e.g., smoke level 924, provided by the user. In particular, the first cooking parameter is provided by the user at the second set point of cavity temperature 922 of three hundred degrees Fahrenheit (300° F.) and the second cooking parameter is provided by the user at the second set point of smoke level 924 of three (3), e.g., the “medium” smoke level. Additionally, the stall phase (the second stage) includes an exit condition, or a stage limit 926, provided by the user to indicate the transition point from the stall phase (the second stage) to the next stage/phase, e.g., to the finish phase (the third stage) at (930). In particular, the exit condition/stage limit 926 provided by the user is a meat probe temperature of one hundred and seventy five degrees Fahrenheit (175° F.).

As may be seen in FIG. 10, the cavity temperature, indicated by line 1010, is transitioned from two hundred and twenty five degrees Fahrenheit (225° F.) up to three hundred degrees Fahrenheit (300° F.), where the temperature is held for the duration of the stall phase. In general, raising the cavity temperature after the smoke phase may push or urge the brisket through the stall quicker than if the temperature remained constant from the smoke phase 910. For example, the cavity temperature is raised and then held constant at the higher temperature until the exit condition/stage limit 926 is met, e.g., the stall phase exit condition/stage limit is the meat probe temperature indicated by line 1020. In particular, during the stall phase (the second stage), the cavity temperature 1010 is raised from the smoke phase 910 and is then held constant, thus the meat probe temperature 1020 may gradually rise to the stall phase exit condition/stage limit 926.

Referring now to FIG. 9B, in the exemplary cooking profile 900, the third stage is a finish phase 930. In particular, the finish phase 930 includes a cavity temperature set point 932 and a smoke level setpoint 934, with a temperature-based exit condition 936. In particular, the finish phase 930 includes a third set point of the first cooking parameter, e.g., cavity temperature 932, and a third set point of the second cooking parameter, e.g., smoke level 934, provided by the user. In particular, the first cooking parameter is provided by the user at the third set point of cavity temperature 932 of two hundred degrees Fahrenheit (200° F.) and the second cooking parameter is provided by the user at the third set point of smoke level 934 of two (2), e.g., a “medium-low” smoke level. Additionally, the finish phase (the third stage) includes an exit condition, or a stage limit 936, provided by the user to indicate the transition point from the finish phase (the third stage) to the keep warm phase (the fourth stage) at (940). In particular, the exit condition/stage limit 936 provided by the user is a meat probe temperature of one hundred and ninety five degrees Fahrenheit (195° F.).

As may be seen in FIG. 10, the cavity temperature, indicated by line 1010, is transitioned from three hundred degrees Fahrenheit (300° F.) down to two hundred degrees Fahrenheit (200° F.), where the temperature is held for the duration of the finish phase. In general, dropping/reducing the cavity temperature after the stall phase may continue to cook the brisket through the finish phase, without overcooking and/or drying out the meat. For example, the cavity temperature is reduced and then held constant at the lower temperature until the exit condition/stage limit 936 is met, e.g., the finish phase exit condition/stage limit is the meat probe temperature indicated by line 1020. In particular, during the finish phase (the third stage), the cavity temperature 1010 is reduced from the stall phase 920 and is then held constant, thus the meat probe temperature 1020 may gradually rise to the finish phase exit condition/stage limit 936.

Referring still to FIG. 9B, in the exemplary cooking profile 900, the fourth stage is a keep warm phase 940. In particular, the keep warm phase 940 includes a cavity temperature set point 942 and a smoke level setpoint 944, with a time-based exit condition 946. In particular, the keep warm phase 940 includes a fourth set point of the first cooking parameter, e.g., cavity temperature 942, and a fourth set point of the second cooking parameter, e.g., smoke level 944, provided by the user. In particular, the first cooking parameter is provided by the user at the fourth set point of cavity temperature 942 of one hundred and forty degrees Fahrenheit (140° F.) and the second cooking parameter is provided by the user at the fourth set point of smoke level 934 of zero (0), e.g., no smoke generation. Additionally, the keep warm phase (the fourth stage) includes an exit condition, or a stage limit 946, provided by the user to indicate the end of the keep warm phase 940 (the fourth stage), and in the present example embodiment, the end of example cooking profile 900. In particular, the exit condition/stage limit 936 provided by the user is a time limit of twenty four hours (24 h).

As may be seen in FIG. 10, the cavity temperature, indicated by line 1010, is transitioned from two hundred degrees Fahrenheit (200° F.) down to one hundred and forty degrees Fahrenheit (140° F.), where the temperature is held for the duration of the keep warm phase. In general, dropping/reducing the cavity temperature after the finish phase may keep the brisket warm, such as for desired consumption, without continuing to cooking (overcooking) and/or drying out the meat. For example, the cavity temperature is reduced and then held constant at the lower temperature until either the exit condition/stage limit 946 is met, or a user input terminates the cooking profile 900. In particular, during the keep warm phase (the fourth stage), the cavity temperature 1010 is reduced from the finish phase 930 and is then held constant, thus the meat probe temperature 1020 may gradually reduce as the cooking profile reaches the finish phase exit condition/stage limit 946.

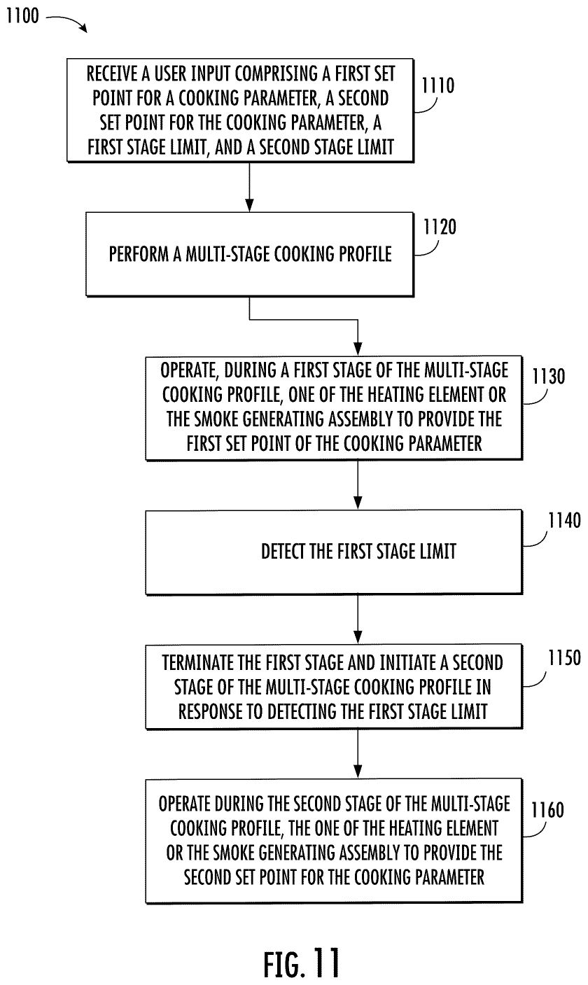

Referring now to FIG. 11, a flow diagram of one embodiment of a method 1100 of operating an indoor smoker is illustrated in accordance with aspects of the present subject matter. In general, the method 1100 will be described herein with reference to the embodiments of the indoor smoker 100 described above with reference to FIGS. 1-10. However, it should be appreciated by those of ordinary skill in the art that the disclosed method 1100 may generally be utilized in association with cooking apparatuses and systems having any other suitable configuration. In addition, although FIG. 11 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 11, at (1110), method 1100 may generally include receiving a user input which includes a first set point for a cooking parameter, a second set point for the cooking parameter, a first stage limit, and a second stage limit. In general, the user input may be an input on user interface panel 134 of indoor smoker 100. For example, the user input may include a first set point for a cavity or a chamber temperature (e.g., baking temperature), a second set point for the cavity or chamber temperature, a first stage limit of a meat probe temperature, and a second stage limit of a time. Other example embodiments may include other cooking parameters such as smoke level. In particular, the user input may include a first set point for a smoke level (e.g., smoke intensity), a second set point for the smoke level. As such, in this current example, the cooking parameter of cavity temperature is a first cooking parameter, and the user input may further include a first set point for a second cooking parameter, e.g., the smoke level, and a second set point for the second cooking parameter. It is to be understood that the example cooking parameters used to describe method 1100 in FIG. 10 are provided by way of example only, e.g., multi-stage cooking profiles according to various embodiments of the present invention may be used with a varying number of cooking parameters, the values of the one or more cooking parameters may vary, etc.

At (1120), method 1100 may generally include performing a multi-stage cooking profile. In general, performing the multi-stage cooking profile may include operating smoke generating assembly 150 as well as chamber heater 170 to smoke and bake food as desired. In particular, the user may define the multi-stage cooking profile in order to cook the food as desired.

For example, at (1130) the multi-stage cooking profile may include operating, by the controller during a first stage of the multi-stage cooking profile, one of the heating element or the smoke generating assembly to provide the first set point of the cooking parameter. For example, operating one of the heating element or the smoke generating assembly to provide the first set point of the cooking parameter may include operating the heating element, such as chamber heater 170, to provide the first set point of the chamber temperature.

Additionally or alternatively, the method may include operating, by the controller during the first stage of the multi-stage cooking profile, the other of the heating element or the smoke generating assembly to provide the first set point of the second cooking parameter. For example, the second cooking parameter may include a smoke level, where operating one of the heating element or the smoke generating assembly to provide the first set point of the second cooking parameter includes operating smoke generating assembly 150 to provide the first set point of the smoke level.

At (1140), the multi-stage cooking profile may include detecting, by the controller, the first stage limit. For example, the first stage limit may include a meat probe temperature. For example, the user input may further include a first meat probe temperature, where detecting the first stage limit may include detecting the first meat probe temperature. Additionally or alternatively, the first stage limit may include a time, e.g., the user input may further include a first specified time, where detecting the first stage limit includes detecting the first specified time. In general, the specified time may be between five minutes (5 m) and twenty four hours (24 h), such as between thirty minutes (30 m) and twelve hours (12 h), such as between one hour (1 h) and six hours (6 h).

At (1150), method 1100 may generally include terminating the first stage and initiating a second stage of the multi-stage cooking profile in response to detecting the first stage limit. For example, in response to detecting the first stage limit, e.g., the first meat probe temperature and/or the first specified time, controller 140 may begin to adjust the operation of smoke generating assembly 150 and/or chamber heater 170 to the set point(s) of the second stage.

At (1160), method 1100 may generally include operating, by the controller during the second stage of the multi-stage cooking profile, the one of the heating element or the smoke generating assembly to provide the second set point for the cooking parameter. For example, operating the one of the heating element or the smoke generating assembly to provide the second set point for the cooking parameter may include operating the heating element, e.g., chamber heater 170, to provide the second set point of the chamber temperature.

Additionally or alternatively, the method may include operating, by the controller during the second stage, the other of the heating element or the smoke generating assembly to provide the second set point of the second cooking parameter. For example, operating the one of the heating element or the smoke generating assembly to provide the second set point for the second cooking parameter may include operating smoke generating assembly 150 to provide the second set point of the smoke level.

In general, method 1100 may further include detecting, by the controller, the second stage limit. For example, the user input may further include a second meat probe temperature for the second stage limit and/or a second specified time for the second stage limit. Additionally, method 1100 may include providing a user notification, such as a sound or message (e.g., on display component 138), in response to progressing through each stage, e.g., the first stage, the second stage, etc., of the cooking profile. For example, method 1100 may include providing a user notification in response to operating the one of the heating element or the smoke generating assembly to provide the first set point of the cooking parameter during the first stage of the multi-stage cooking profile, in response to detecting the first stage limit, in response to operating the one of the heating element or the smoke generating assembly to provide the second set point for the cooking parameter during the second stage of the multi-stage cooking profile, and in response to detecting the second stage limit.

As may be seen from the above, a multi-stage cooking profile may be input by a user or by a manufacturer. The multi-stage cooking profile may include variables such as chamber (baking) temperature and smoke level (intensity), and end conditions or stage limits such as time and/or a meat probe temperature. The user may provide a user input indicative of each of the chamber temperature, smoke level, time, and/or a meat probe temperature for each individual stage of the cooking profile, e.g., customizing the multi-stage cooking profile in order to cook food in a desired way.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating an indoor smoker, the indoor smoker comprising a cabinet defining a smoking chamber, a heating element configured for heating the smoking chamber, a smoke generating assembly configured for providing smoke into the smoking chamber, and a controller in operative communication with the heating element and the smoke generating assembly, the method comprising:
receiving, at the controller, a user input comprising a first set point for a cooking parameter, a second set point for the cooking parameter, a first stage limit, and a second stage limit; and
performing, by the controller, a multi-stage cooking profile, the multi-stage cooking profile comprising:
operating, by the controller during a first stage of the multi-stage cooking profile, one of the heating element or the smoke generating assembly to provide the first set point of the cooking parameter;
detecting, by the controller, the first stage limit;
terminating the first stage and initiating a second stage of the multi-stage cooking profile in response to detecting the first stage limit; and
operating, by the controller during the second stage of the multi-stage cooking profile, the one of the heating element or the smoke generating assembly to provide the second set point for the cooking parameter.

2. The method of claim 1, further comprising:
detecting, by the controller, the second stage limit; and
providing, by the controller, a user notification in response to detecting the second stage limit.

3. The method of claim 1, wherein the cooking parameter is a first cooking parameter, the user input further comprising a first set point for a second cooking parameter and a second set point for the second cooking parameter, the method further comprising operating, by the controller during the first stage of the multi-stage cooking profile, the other of the heating element or the smoke generating assembly to provide the first set point of the second cooking parameter, and operating, by the controller during the second stage, the other of the heating element or the smoke generating assembly to provide the second set point of the second cooking parameter.

4. The method of claim 1, wherein the cooking parameter comprises a chamber temperature, wherein operating one of the heating element or the smoke generating assembly to provide the first set point of the cooking parameter comprises operating the heating element to provide the first set point of the chamber temperature, and operating the one of the heating element or the smoke generating assembly to provide the second set point for the cooking parameter comprises operating the heating element to provide the second set point of the chamber temperature.

5. The method of claim 1, wherein the cooking parameter comprises a smoke level, wherein operating one of the heating element or the smoke generating assembly to provide the first set point of the cooking parameter comprises operating the smoke generating assembly to provide the first set point of the smoke level, and operating the one of the heating element or the smoke generating assembly to provide the second set point for the cooking parameter comprises operating the smoke generating assembly to provide the second set point of the smoke level.

6. The method of claim 1, wherein the first stage limit comprises a meat probe temperature, the user input further comprising a first meat probe temperature, wherein detecting the first stage limit comprises detecting the first meat probe temperature.

7. The method of claim 6, wherein the user input further comprises a second meat probe temperature for the second stage limit.

8. The method of claim 1, wherein the first stage limit comprises a time, the user input further comprising a first specified time, wherein detecting the first stage limit comprises detecting the first specified time.

9. The method of claim 8, wherein the user input further comprises a second specified time for the second stage limit.

10. The method of claim 1, further comprising: providing, by the controller, a user notification in response to operating the one of the heating element or the smoke generating assembly to provide the first set point of the cooking parameter during the first stage of the multi-stage cooking profile, and operating the one of the heating element or the smoke generating assembly to provide the second set point for the cooking parameter during the second stage of the multi-stage cooking profile.

11. An indoor smoker, comprising:
a cabinet defining a smoking chamber;
a heating element configured for heating the smoking chamber;
a smoke generating assembly configured for providing smoke into the smoking chamber; and
a controller in operative communication with the heating element and the smoke generating assembly, the controller configured to:
receive a user input comprising a first set point for a cooking parameter, a second set point for the cooking parameter, a first stage limit, and a second stage limit; and
perform a multi-stage cooking profile, the multi-stage cooking profile comprising:
operating, by the controller during a first stage of the multi-stage cooking profile, one of the heating element or the smoke generating assembly to provide the first set point of the cooking parameter;
detecting, by the controller, the first stage limit;
terminating the first stage and initiating a second stage of the multi-stage cooking profile in response to detecting the first stage limit; and
operating, by the controller during the second stage of the multi-stage cooking profile, the one of the heating element or the smoke generating assembly to provide the second set point for the cooking parameter.

12. The indoor smoker of claim 11, wherein the multi-stage cooking profile further comprises:
detecting, by the controller, the second stage limit; and
providing, by the controller, a user notification in response to detecting the second stage limit.

13. The indoor smoker of claim 11, wherein the cooking parameter is a first cooking parameter, the user input further comprising a first set point for a second cooking parameter and a second set point for the second cooking parameter, the controller further configured to operate, during the first stage of the multi-stage cooking profile, the other of the heating element or the smoke generating assembly to provide the first set point of the second cooking parameter, and operate, during the second stage, the other of the heating element or the smoke generating assembly to provide the second set point of the second cooking parameter.

14. The indoor smoker of claim 11, wherein the cooking parameter comprises a chamber temperature, wherein operating one of the heating element or the smoke generating assembly to provide the first set point of the cooking parameter comprises the controller configured to operate the heating element to provide the first set point of the chamber temperature, and operating the one of the heating element or the smoke generating assembly to provide the second set point for the cooking parameter comprises the controller configured to operate the heating element to provide the second set point of the chamber temperature.

15. The indoor smoker of claim 11, wherein the cooking parameter comprises a smoke level, wherein operating one of the heating element or the smoke generating assembly to provide the first set point of the cooking parameter comprises the controller configured to operate the smoke generating assembly to provide the first set point of the smoke level, and operating the one of the heating element or the smoke generating assembly to provide the second set point for the cooking parameter comprises the controller configured to operate the smoke generating assembly to provide the second set point of the smoke level.

16. The indoor smoker of claim 11, wherein the first stage limit comprises a meat probe temperature, the user input further comprising a first meat probe temperature, wherein detecting the first stage limit comprises the controller further configured to detect the first meat probe temperature.

17. The indoor smoker of claim 16, wherein the user input further comprises a second meat probe temperature for the second stage limit.

18. The indoor smoker of claim 11, wherein the first stage limit comprises a time, the user input further comprising a first specified time, wherein detecting the first stage limit comprises the controller further configured to detect the first specified time.

19. The indoor smoker of claim 18, wherein the user input further comprises a second specified time for the second stage limit.

20. The indoor smoker of claim 11, wherein the controller is further configured to provide a user notification in response to operating the one of the heating element or the smoke generating assembly to provide the first set point of the cooking parameter during the first stage of the multi-stage cooking profile, and operating the one of the heating element or the smoke generating assembly to provide the second set point for the cooking parameter during the second stage of the multi-stage cooking profile.
